(19) United States
(12) Patent Application Publication
(10) Pub. No.: US 2010/0265802 A1
(43) Pub. Date: Oct. 21, 2010

(54) SYSTEM AND METHOD FOR AUTOMATICALLY UPDATING SYSTEM TIME OF A MOBILE COMMUNICATION DEVICE

(75) Inventor: HOU-WEN LAI, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/511,241

(22) Filed: Jul. 29, 2009

(30) Foreign Application Priority Data
Apr. 16, 2009 (CN) 200910301606.8

(51) Int. Cl. G04C 11/02

(52) U.S. Cl. 368/47

(57) ABSTRACT

A method for automatically updating system time of a mobile communication device is provided. The method computes a current time zone of a current position of the mobile communication device according to a longitude and a latitude of the current position determined by satellite signals. The method then updates system time of the mobile communication device according to the current time zone.

### BACKGROUND

1. Technical Field

Embodiments of the present disclosure generally relate to the field of mobile communication, and more particularly to a system and method for automatically updating system time of a mobile communication device.

2. Description of Related Art

Mobile communication devices have become more and more important in daily life. These devices not only provide a function of making telephone calls, but also other functions, such as, a time clock, an alarm clock, or a memorandum, for example.

However, because of time zones, the system time of a mobile communication device may be different from a local time. For example, if a user of the mobile communication device originally lives and works at place “A”, but will go to place “B” for a business trip where place “A” and the place “B” are located in different time zones, the system time of the mobile communication device may be different from the local time of place “B”.

Usually, in order to overcome the inconsistent time, the user needs to manually adjust the system time of the mobile communication device according to the local time. However, adjusting the system time manually is really troublesome for the user. In addition, it is not so easy for the user to exactly know the local time.

### BRIEF DESCRIPTION OF THE DRAWINGS

FIG. 1 is a block diagram of one embodiment of a system for automatically updating system time of a mobile communication device;

FIG. 2 is a block diagram of one embodiment of an updating system included in FIG. 1; and

FIG. 3 is a flowchart illustrating one embodiment of a method for automatically updating system time of a mobile communication device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, a word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprised connected logic units, such as gates and flip-flops, and may comprise programmable units, such as programmable gate arrays or processors. The modules described hereinafter may be implemented as either software and/or hardware modules and may be stored in any type of computer-readable medium or other computer storage device.

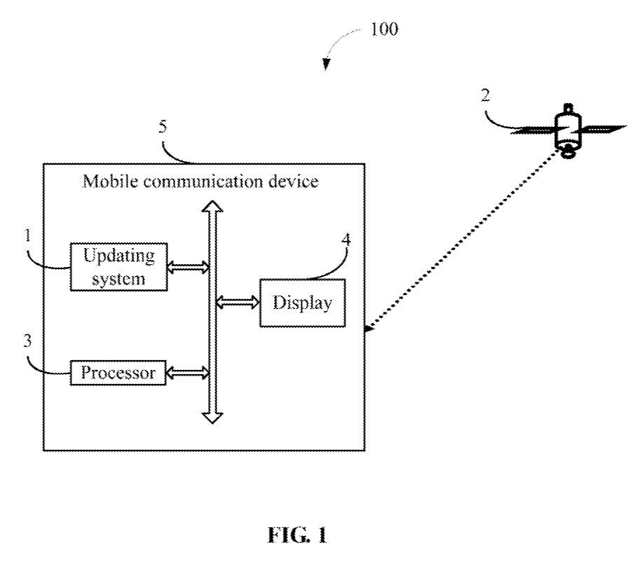

FIG. 1 is a block diagram of one embodiment of a system 100. In one embodiment, the system 100 includes a mobile communication device 5 and a global navigation satellite system (GNSS) 2. The mobile communication device 5 communicates with the GNSS 2. The system 100 can automatically update system time of the mobile communication device 5 according to satellite signals transmitted from the GNSS 2. It may be understood that, the GNSS 2 consists of a plurality of satellites, and provides autonomous geo-spatial positioning with global coverage. In one embodiment, the GNSS 2 may be the global positioning system (GPS), the Compass navigation system (Beidou-2), or the Galileo positioning system, for example.

In one embodiment, the mobile communication device 5 may be an electronic device, such as a mobile phone, a personal digital assistant (PDA), or a portable computer. The mobile communication device 5 may include an updating system 1, which comprises one or more computerized operations to update the system time of the mobile communication device 5. The mobile communication device 5 further includes at least one processor 150 for computation. In addition, a display 4 of the mobile communication device 5 can show the system time.

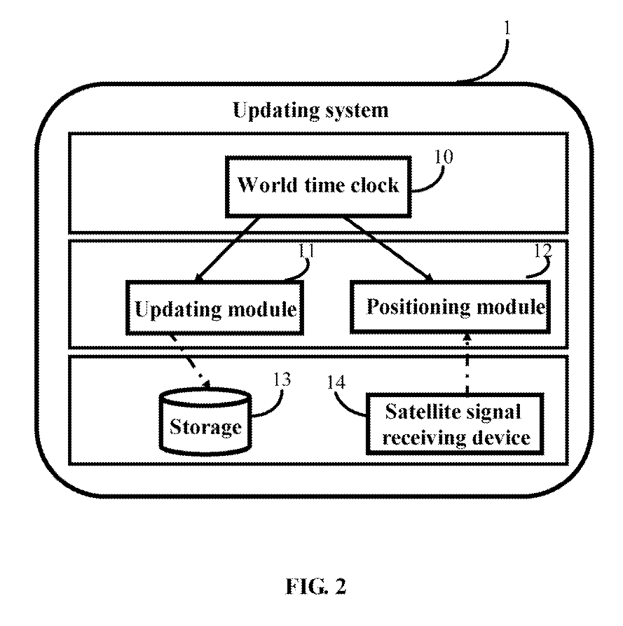

FIG. 2 is a block diagram of one embodiment of the updating system 1. In one embodiment, the updating system 1 may include a world time clock 10, an updating module 11, a positioning module 12, a storage 13, and a satellite signal receiving device 14.

The storage 13 stores a time zone, the system time, and other time data. The other time data includes, such as, alarm times, memorandum times, for example. In one embodiment, the storage 13 may be a memory card, a hard disk, for example.

The satellite signal receiving device 14 can receive satellite signals transmitted from the GNSS 2, such as GPS, for example.

The positioning module 12 is operable to determine a longitude and a latitude of a current position of the mobile communication device 5 according to the satellite signals.

The world time clock 10 is an application installed in the mobile communication device 5. The world time clock 10 is able to compute a current time zone and local time of a position of the mobile communication device 5 according to the longitude and the latitude. It may be understood that, a time zone is a region of the earth that has uniform standard time, and is usually referred to as local time. By convention, local times of a time zone are an offset from the Greenwich mean time (GMT). The local time is GMT plus the current time zone offset for the current position. In addition, a digital map is related to the world time clock 10. The digital map can show the current position according to the longitude and the latitude through the display 4 of the mobile communication device 5.

The updating module 11 is operable to compare the current time zone computed by the world time clock 10 with a stored time zone in the storage 13. When the current time zone is different from the stored time zone, the updating module 11 signals an alert to the mobile communication device 5. The alert may be displayed on the display 4 of the mobile communication device 5 where a user may be prompted to receive and/or ignore the alert. If the alert is received by the user, the updating module 11 is further operable to update the system time of the mobile communication device 5 according to the current time zone. After the system time is updated, the updating module 12 is further operable to update the stored time zone with the current time zone into the storage 13 according to a user input, such as an instruction of updating the stored time zone inputted by the user. In one embodiment, if the stored time zone is updated with the current time zone in the storage 13, the system time of the mobile communication device 5 remains accurate to the local time even if the updated system 1 is restarted. Otherwise, if the stored time zone is not updated, the system time of the mobile communication device 5 will revert to system time corresponding to the update the stored time zone, when the updated system 1 is restarted.

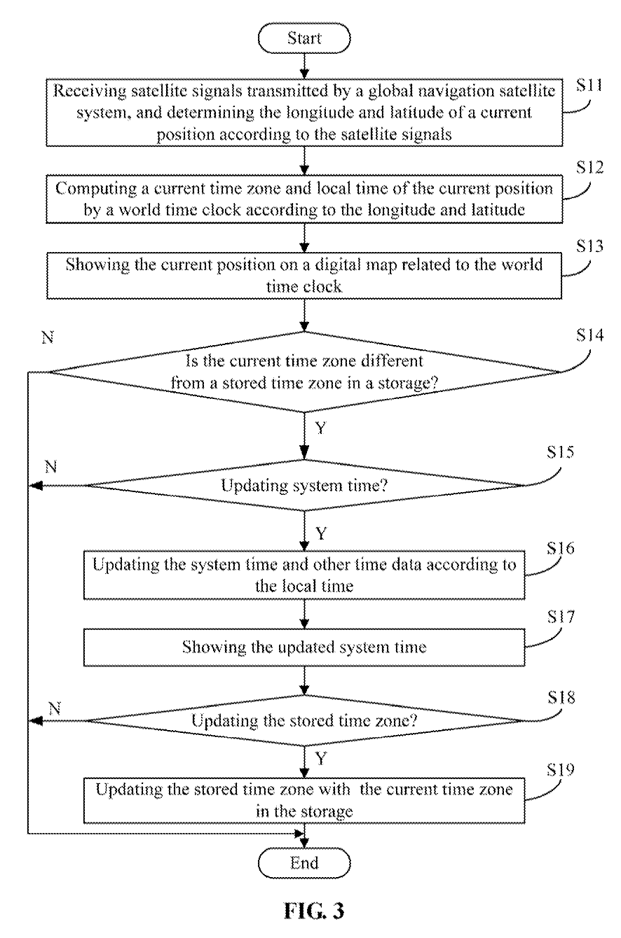

FIG. 3 is a flowchart illustrating one embodiment of a method for automatically updating system time of the mobile communication device 5. Depending on the embodiment, additional blocks in the flow of FIG. 3 may be added, others removed, and the ordering of the blocks may be changed.

In block S11, the satellite signal receiving device 14 receives satellite signals transmitted from the GNSS 2, and the positioning module 12 determines a longitude and a latitude of a current position of the mobile communication device 5 according to the satellite signals. As mentioned above, the GNSS 2 may be the global positioning system (GPS), the compass navigation system, or the Galileo positioning system, for example.

In block S12, the world time clock 10 computes a current time zone and local time of the current position according to the longitude and the latitude of the current position.

In block S13, the world time clock 10 displays a digital map through the display 4 to show the current position.

In block S14, the updating module 11 determines whether the current time zone is different from a stored time zone in the storage 13. If the current time zone is same with the stored time zone, the flow ends. Otherwise, if the current time zone is different from the stored time zone, the flow goes to block S15.

In block S15, the updating module 11 signals a first alert on the display 4 of the mobile communication device 5 for prompting a user whether to update the system time of the mobile communication device 5. If not updating the system time, the flow ends. Otherwise, if updating the system time, the flow goes to block S16.

In block S16, the updating module 11 updates the system time and other time data according to the local time of the current position. As mentioned above, the other time data may include, but not limited to, alarm times, and memorandum times.

In block S17, the updating system 1 shows the updated system time on the display 4 of the mobile communication device 5.

In block S18, the updating module 11 signals a second alert on the display 4 of the mobile communication device 5 for prompting the user whether to update the stored time zone with the current time zone in the storage 13. If the stored time zone is updated with the current time zone in the storage 13, the system time of the mobile communication device 5 remains accurate to the local time even if the updated system 1 is restarted. Otherwise, if the stored time zone is not updated, the system time of the mobile communication device 5 will revert to system time corresponding to the update the stored time zone, when the updated system 1 is restarted. If the stored time zone is not updated, the flow ends. Otherwise, the flow goes to block S19 if the stored time zone is updated with the current time zone in the storage 13.

In block S19, the updating module 11 updated the stored time zone with the current time zone in the storage 13.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for automatically updating system time of a mobile communication device, the mobile communication device having a storage, a world time clock, and a satellite signal receiving device, the method comprising:
receiving satellite signals transmitted from a global navigation satellite system by the satellite signal receiving device;
determining a longitude and a latitude of a current position of the mobile communication device according to the satellite signals;
computing a current time zone and local time of the current position according to the longitude and the latitude by the world time clock;
updating the system time according to the local time of the current position in response to the current time zone being different from a stored time zone in the storage; and
showing the updated system time on a display of the mobile communication device.

2. The method as described in claim 1, further comprising:
showing the current position on a digital map related to the world time clock.

3. The method as described in claim 1, further comprising:
updating time data of the mobile communication device according to the local time of the current position, wherein the time data comprises an alarm time and a memorandum time.

4. The method as described in claim 1, further comprising:
updating the stored time zone with the current time zone in the storage.

5. The method as described in claim 1, wherein the global navigation satellite system is selected from the group consisting of the global positioning system, the Compass navigation system, and the Galileo positioning system.

6. A storage medium having stored thereon instructions that, when executed by a processor, causing the processor to perform a method for automatically updating system time of a mobile communication device, wherein the method comprises:
receiving satellite signals transmitted from a global navigation satellite system;
determining a longitude and a latitude of a current position of the mobile communication device according to the satellite signals;
computing a current time zone and local time of the current position according to the longitude and the latitude;
updating the system time according to the local time of the current position in response to the current time zone being different from a stored time zone; and
showing the updated system time.

7. The storage medium as described in claim 6, wherein the method further comprises:
showing the current position on a digital map in the mobile communication device.

8. The storage medium as described in claim 6, wherein the method further comprises:
updating time data of the mobile communication device according to the local time of the current position, wherein the time data comprises an alarm time and a memorandum time.

9. The storage medium as described in claim 6, wherein the method further comprises:
updating the stored time zone with the current time zone in a storage.

10. The storage medium as described in claim 6, wherein the global navigation satellite system is selected from the group consisting of the global positioning system, the Compass navigation system, and the Galileo positioning system.

11. A system for automatically updating system time of a mobile communication device, the system comprising:
a storage which stores a time zone and system time;
a satellite signal receiving device operable to receive satellite signals transmitted from a global navigation satellite system;
a positioning module operable to determine a longitude and a latitude of a current position of the mobile communication device according to the satellite signals.
a world time clock operable to compute a current time zone and local time of the current position according to the longitude and the latitude; and
an updating module operable to compare the current time zone with a stored time zone in the storage, and update the system time of the mobile communication device according to the local time in response to the current time zone being different from the stored time zone.

12. The system as described in claim 11, wherein the world time clock is further operable to show the current position on a related digital map through a display of the mobile communication device.

13. The system as described in claim 11, wherein the storage further stores time data comprising an alarm time and a memorandum time.

14. The system as described in claim 13, wherein the updating module is further operable to update the time data according to the local time.

15. The system as described in claim 11, wherein the updating module is further operable to update the stored time zone with the current time zone in the storage.

16. The system as described in claim 11, wherein the global navigation satellite system is selected from the group consisting of the global positioning system, the Compass navigation system, and the Galileo positioning system.
